(19) United States
(12) Patent Application Publication
(10) Pub. No.: US 2015/0345628 A1
(43) Pub. Date: Dec. 3, 2015

(54) POWER MANAGEMENT SYSTEM AND METHOD FOR POWER GENERATION APPARATUS

(71) Applicant: Caterpillar Paving Products Inc., Minneapoils, MN (US)

(72) Inventors: Eric S. Engelmann, Delano, MN (US); James A. Aardema, Plymouth, MN (US)

(73) Assignee: Caterpillar Paving Products Inc., Minneapoils, MN (US)

(21) Appl. No.: 14/288,515

(22) Filed: May 28, 2014

(51) Int. Cl. F16H 61/478; E02F 9/22; F16H 61/42

(52) U.S. Cl. CPC F16H 61/478; F16H 61/42; E02F 9/2267

(57) ABSTRACT

A power management system is provided. The power management system includes a power generation apparatus and a pump drivably coupled to the power generation apparatus. The power management system also includes a valve in fluid communication with the pump. The valve and the pump are components of a hydraulic circuit. The power management system further includes a controller communicably coupled to the valve. The controller is configured to selectively regulate the valve in order to control a pressure in the hydraulic circuit in a predetermined manner such that a torque load placed on the power generation apparatus by the pump lies below a threshold torque.

### TECHNICAL FIELD

The present disclosure relates to a system and method for managing power in a power generation apparatus, and more specifically to a power generation apparatus associated with a hydraulic implement.

### BACKGROUND

Machines employ a Power Take-Off (PTO) unit to transfer power between a prime mover and one or more hydraulic pumps associated with an implement. During start up and/or transient conditions during operation of the implement, the hydraulic pumps may place a high amount of torque loading on the PTO unit. The hydraulic pumps may exceed the torque rating of the PTO and/or the prime mover, for example, during transient conditions. Such a situation may be detrimental to components of the PTO unit and/or the prime mover. This may result in reduced component life, frequent component failures, increased service intervals, increased maintenance costs, reduced system efficiency and utilization, and so on.

U.S. Patent Application Publication Number 2013/312397 discloses a method and apparatus for controlling a hydraulic power system. The apparatus includes a hydraulic motor and a hydraulic pump configured to supply hydraulic fluid to the hydraulic motor. The apparatus includes a relief valve configured to release hydraulic fluid from a location between the hydraulic pump and the hydraulic motor when a pressure of the hydraulic fluid exceeds a predetermined relief pressure. Above a predetermined threshold pressure for the system, the displacement of the pump is adjusted to at least a minimum displacement that is based on a total demanded flow for the system that includes a desired flow of hydraulic fluid across the relief valve and a first hydraulic fluid flow consumed by the motor.

### SUMMARY OF THE DISCLOSURE

In one aspect of the present disclosure, a power management system is provided. The power management system includes a power generation apparatus. The power management system includes a pump drivably coupled to the power generation apparatus. The power management system also includes a valve in fluid communication with the pump. The valve and the pump are components of a hydraulic circuit. The power management system further includes a controller communicably coupled to the valve. The controller is configured to selectively regulate the valve in order to control a pressure in the hydraulic circuit in a predetermined manner such that a torque load placed on the power generation apparatus by the pump lies below a threshold torque.

In another aspect of the present disclosure, a machine is provided. The machine includes a power generation apparatus. The machine includes a pump drivably coupled to the power generation apparatus. The machine includes a valve in fluid communication with the pump. The pump and the valve are components of a hydraulic circuit. The machine also includes an implement driven by a fluid from the hydraulic circuit. The machine further includes a controller communicably coupled to the valve. The controller is configured to selectively regulate the valve in order to control a pressure in the hydraulic circuit in a predetermined manner such that a torque load placed on the power generation apparatus by the pump lies below a threshold torque.

In yet another aspect of the present disclosure, a method of managing power in a power generation apparatus drivably coupled to a pump is provided. The method includes determining a threshold torque associated with the power generation apparatus. The method also includes regulating a valve in fluid communication with the pump in order to control a pressure in a predetermined manner in a hydraulic circuit such that a torque load placed on the power generation apparatus by the pump lies below the threshold torque.

Other features and aspects of this disclosure will be apparent from the following description and the accompanying drawings.

### BRIEF DESCRIPTION OF THE DRAWINGS

FIG. 1 is a block diagram of a power management system for a power generation apparatus, according to an embodiment of the present disclosure; and

FIG. 2 is an exemplary graphical representation of working of the power generation apparatus, according to an embodiment of the present disclosure.

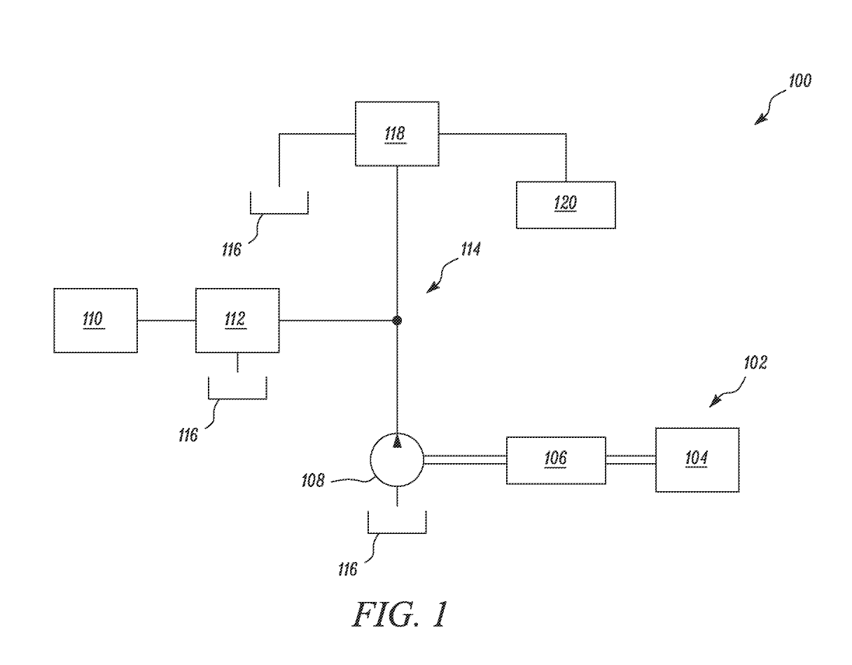

### DETAILED DESCRIPTION

Wherever possible, the same reference numbers will be used throughout the drawings to refer to the same or similar parts. Referring to FIG. 1, a block diagram of a power management system 100 for a power generation apparatus 102 is illustrated. More specifically, the power generation apparatus 102 is associated with a machine (not shown). The machine may be any machine known in the art, such as a compactor. In other embodiments, the machine may be any other machine associated with the agriculture, construction, transportation, forestry, mining, material handling and waste management industries.

The power generation apparatus 102 includes a prime mover 104. The prime mover 104 may be any power source known in the art, such as a diesel engine. In other embodiments, the prime mover 104 may be a gasoline engine, a gas powered engine and so on. The prime mover 104 is configured to provide power to one or more components of the machine for mobility and/or operational requirements.

Further, the machine includes a Power Take-Off (PTO) unit 106 coupled to the prime mover 104. The PTO unit 106 is configured to be driven by the prime mover 104. The PTO unit 106 may be further coupled to any other component of the machine such as a pump 108, and so on. The PTO unit 106 is also configured to provide power to the other components of the machine for operational requirements.

In an embodiment, an implement 110 may be a vibratory apparatus configured to compact asphalt during a road paving operation. The implement 110 is coupled to a hydraulic motor 112. In other embodiments, the machine may include one or more hydraulic motors 112 coupled to one or more loads. The exemplary loads may be the implement 110, other implements (not shown), a machine steering unit (not shown), auxiliary systems (not shown) and so on. The hydraulic motor 112 may be any motor known in the art capable of being driven by a fluid. The hydraulic motor 112 is configured to provide motive power to the implement 110 for operational requirements. The implement 110 and/or the hydraulic motor 112 is coupled to and powered by the power generation apparatus 102 which will be explained later in detail.

The machine includes a hydraulic circuit 114 coupled to the power generation apparatus 102 and the hydraulic motor 112 associated with the implement 110. The hydraulic circuit 114 is configured to provide motive power to the hydraulic motor 112 associated with the implement 110 for operational requirements. The hydraulic circuit 114 includes a tank 116. The tank 116 is configured to store a fluid of the hydraulic circuit 114. The fluid may be any hydraulic fluid such as oil used in hydraulic systems.

The hydraulic circuit 114 includes the pump 108 fluidly coupled to the tank 116 and the implement 110. The pump 108 is drivably coupled to the prime mover 104 through the PTO unit 106. The pump 108 is configured to pressurize the fluid received from the tank 116. The pump 108 is further configured to supply the pressurized fluid to the hydraulic motor 112 associated with the implement 110. The hydraulic circuit 114 also includes a valve 118. The valve 118 is provided in fluid communication with the pump 108 and the hydraulic motor 112. More specifically, the valve 118 is provided in a parallel arrangement with respect to the hydraulic motor 112. More specifically, a fluid connection from the pump 108 branches out in order to fluidly connect the pump 108 to the hydraulic motor 112 at one location and the valve 118 at other location. The valve 118 may be any valve known in the art such as an electrohydraulic pressure relief valve. The valve 118 is configured to discharge the fluid in the hydraulic circuit 114 to the tank 116 based on a set point pressure which will be explained later in detail.

The power management system 100 includes a controller 120 communicably coupled to the valve 118. The controller 120 is configured to selectively regulate the valve 118 in order to control the pressure in the hydraulic circuit 114 in a predetermined manner such that a torque load placed by the pump 108 on the PTO unit 106, the prime mover 104 and/or the power generation apparatus 102 lies below a threshold torque. It should be noted the threshold torque is a design torque limit of the PTO unit 106. The threshold torque/design torque limit is selected in order to prevent overloading the PTO unit 106 by the pump 108. More specifically, the threshold torque/design torque limit is configured to prevent damage to the PTO unit 106 during sudden surge in power demand by the pump 108. Such a situation may occur during start up of the implement 110 or transient conditions during operation of the implement 110.

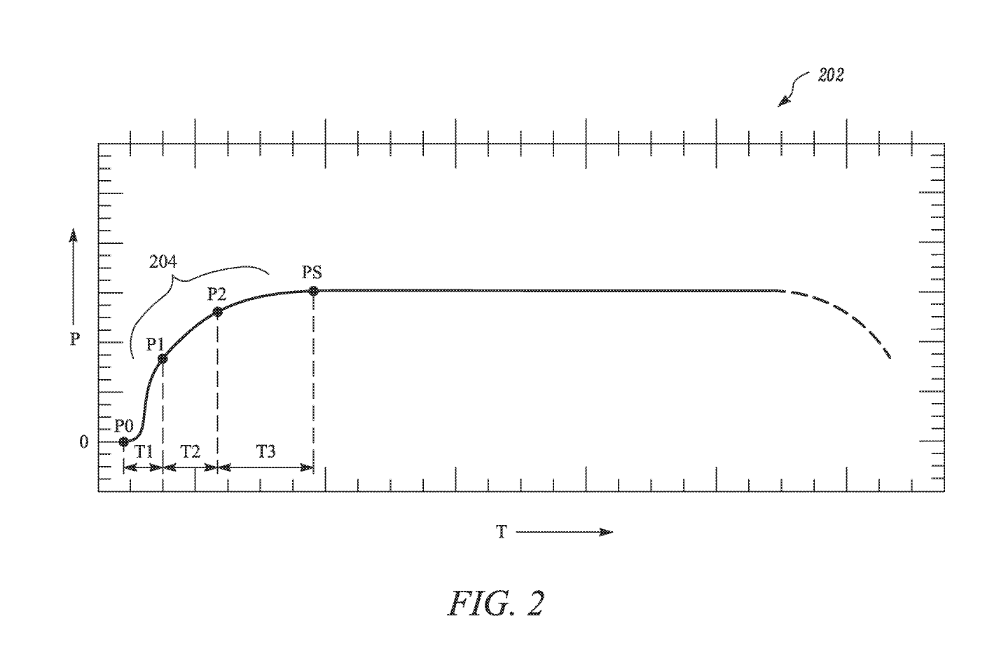

Referring to FIG. 2, an exemplary graphical representation 202 of working of the power management system 100 is illustrated. The graphical representation 202 includes time values “T” along an X-axis and values of the pressure “P” in the hydraulic circuit 114 along a Y-axis. Before start up of the implement 110, the pressure “P” in the hydraulic circuit 114 is low as shown by an initial pressure “P0”. As the implement 110 is switched on, the controller 120 is configured to regulate the set point pressure associated with the valve 118 in order to control the pressure “P” in the hydraulic circuit 114.

For example, the controller 120 is configured to control the pressure “P” in the hydraulic circuit 114 from the initial pressure “P0” to a first set point pressure “P1” based on a first predetermined amount of time “T1”. More specifically, the controller 120 is configured to regulate the valve 118 for the first predetermined amount of time “T1” during which the pressure “P” in the hydraulic circuit 114 increases gradually by incremental values from the initial pressure “P0” to the first set point pressure “P1”. When the pressure “P” in the hydraulic circuit 114 reaches the first set point pressure “P1”, the controller 120 may actuate the valve 118 to discharge the fluid in the hydraulic circuit 114 to the tank 116 such that the pressure “P” in the hydraulic circuit 114 is maintained at the first set point pressure “P1”.

Further, the controller 120 is configured to control the pressure “P” in the hydraulic circuit 114 from the first set point pressure “P1” to a second set point pressure “P2” based on a second predetermined amount of time “T2” and so on. More specifically, the controller 120 is configured to regulate the valve 118 for the second predetermined amount of time “T2” during which the pressure “P” in the hydraulic circuit 114 increases gradually by incremental values from the first set point pressure “P1” to the second set point pressure “P2”. When the pressure “P” in the hydraulic circuit 114 reaches the second set point pressure “P2”, the controller 120 may actuate the valve 118 to discharge the fluid in the hydraulic circuit 114 to the tank 116 such that the pressure “P” in the hydraulic circuit 114 is maintained at the second set point pressure “P2”.

Further, the controller 120 is configured to control the pressure “P” in the hydraulic circuit 114 from the second set point pressure “P2” to a steady state pressure “PS” as required by the hydraulic motor 112 associated with the implement 110 in a third predetermined amount of time “T3”. More specifically, the controller 120 is configured to regulate the valve 118 for the third predetermined amount of time “T3” during which the pressure “P” in the hydraulic circuit 114 increases gradually by incremental values from the second set point pressure “P2” to the steady state pressure “PS”. When the pressure “P” in the hydraulic circuit 114 reaches the steady state pressure “PS”, the controller 120 may actuate the valve 118 to discharge the fluid in the hydraulic circuit 114 to the tank 116 such that the pressure “P” in the hydraulic circuit 114 is maintained at the steady state pressure “PS” The steady state pressure “PS” refers to a rated pressure of the hydraulic motor 112 required for operation of the implement 110. It should be noted that the controller 120 may set additional series of set point pressures (not shown) similar to the exemplary first and second set point pressures “P1”, “P2” in order to gradually ramp up the pressure “P” in the hydraulic circuit 114 from the initial pressure “P0” to the steady state pressure “PS”.

In other words, the controller 120 is configured to control the set point pressure associated with the valve 118 progressively by incremental pressure values up to the steady state pressure “PS”. This ensures that during start up or transient conditions during operation of the implement 110, the pressure “P” in the hydraulic circuit 114 gradually rises up to the steady state pressure “PS” from the initial pressure “P0”, as shown by a curve 204, without a sudden spike. This in turn prevents sudden loading by the pump 108 on the PTO unit 106 and/or the prime mover 104. It should be noted that the number of set point pressures, incremental difference in successive set point pressures, values of the predetermined amounts of time, difference in the values of the successive predetermined amounts of time may vary based on system design and requirements and may not limit the scope of the disclosure.

The controller 120 is configured to control the pressure “P” in the hydraulic circuit 114 in the predetermined manner based on a predetermined relationship between the time values “T” and the values of the pressure “P” in the hydraulic circuit 114. The predetermined relationship may refer to a predetermined reference map stored in a database (not shown) accessible by the controller 120 or an internal memory of the controller 120. The reference map may include predetermined readings of the time values “T” corresponding to different values of the pressure “P” in the hydraulic circuit 114. In another embodiment, the predetermined relationship may be a predetermined mathematical equation. The mathematical equation may include a multiple polynomial regression model, a physics based model, a neural network model or any other model or algorithm known in the art.

Further, the controller 120 is also configured to control the pressure “P” in the hydraulic circuit 114 in the predetermined manner such that a change of the torque load placed on the PTO unit 106, the prime mover 104 and/or the power generation apparatus 102 lies below a threshold rate. It should be noted the threshold rate is a limit of change of torque placed on the PTO unit 106, the prime mover 104 and/or the power generation apparatus 102.

The threshold rate is selected in order to prevent overloading the PTO unit 106 by the pump 108. More specifically, the threshold rate is selected to prevent damage to the PTO unit 106 during sudden surge in power demand by the pump 108. Such a situation may occur during start up or transient conditions during operation of the implement 110. This ensures that during start up or transient conditions during operation of the implement 110, the pressure “P” in the hydraulic circuit 114 gradually rises up to the steady state pressure “PS” from the initial pressure “P0”, as shown by the curve 204, without any sudden spike. This in turn prevents sudden loading by the pump 108 on the PTO unit 106 and/or the prime mover 104.

### INDUSTRIAL APPLICABILITY

A machine, such as a paving compactor, may employ an implement, such as a vibratory apparatus. The implement may be powered by a pump and a hydraulic motor which may be coupled to a PTO unit. During start up or transient conditions during operation of the implement, as the pump pressure increases, the torque load on the PTO unit may increase. In some circumstances, the pressure and the torque load may increase rapidly resulting in the sudden spike in power demand. During transient conditions, the pressure and the torque load may suddenly surge to a level that may cause damage to the components of the PTO unit and/or the prime mover such as gears.

The present disclosure relates to a method of managing power in the power generation apparatus 102. The controller 120 determines the threshold torque associated with the power generation apparatus 102. The threshold torque is based on the set point pressure. Further, the controller 120 selectively regulates the valve 118 provided in fluid communication with the pump 108 in order to control the pressure “P” in the hydraulic circuit 114 in the predetermined manner such that the torque load placed on the power generation apparatus 102 by the pump 108 lies below the threshold torque. More specifically, the controller 120 regulates the valve 118 in order to control the pressure “P” in the hydraulic circuit 114 in the predetermined manner such that the torque load placed by the pump 108 on the PTO unit 106 and/or the prime mover 104 lies below the threshold torque.

The hydraulic circuit 114 is associated with the implement 110 such as the vibratory apparatus of the paving compactor. The valve 118 is the electrohydraulic pressure relief valve configured to discharge the fluid in the hydraulic circuit 114 to the tank 116 based on the set point pressure. The controller 120 regulates the set point pressure associated with the valve 118 in order to control the pressure “P” in the hydraulic circuit 114.

The controller 120 then controls the set point pressure associated with the valve 118 progressively by incremental pressure values up to the steady state pressure “PS”. This ensures that during start up or transient conditions during operation of the implement 110, the pressure “P” in the hydraulic circuit 114 gradually rises up to the steady state pressure “PS” from the initial pressure “P0”, as shown by the curve 204, without the sudden spike. This in turn prevents sudden loading by the pump 108 on the PTO unit 106 and/or the prime mover 104.

Further, the controller 120 controls the pressure “P” in the hydraulic circuit 114 in the predetermined manner such that the change of the torque load placed on the PTO unit 106, the prime mover 104 and/or the power generation apparatus 102 lies below the threshold rate. The threshold rate is configured in order to prevent overloading the PTO unit 106 by the pump 108. More specifically, the threshold rate is configured to prevent damage to the PTO unit 106 during sudden surge in power demand by the pump 108.

Such a situation may occur during start up or transient conditions during operation of the implement 110. This ensures that during start up or transient conditions during operation of the implement 110, the pressure “P” in the hydraulic circuit 114 gradually rises up to the steady state pressure “PS” from the initial pressure “P0”, as shown by the curve 204, without the sudden spike. This in turn prevents sudden loading by the pump 108 on the PTO unit 106 and/or the prime mover 104. A strategy for setting/altering the set point pressure by the controller 120 may be pre-stored in the database for different parameters and/or operational conditions of the machine. Additionally, the strategy may be modified for different machine types on which the power management system 100 may be installed.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A power management system comprising:
a power generation apparatus;
a pump drivably coupled to the power generation apparatus;
a valve in fluid communication with the pump, wherein the valve and the pump are components of a hydraulic circuit; and
a controller communicably coupled to the valve, wherein the controller is configured to selectively regulate the valve in order to control a pressure in the hydraulic circuit in a predetermined manner such that a torque load placed on the power generation apparatus by the pump lies below a threshold torque.

2. The power management system of claim 1, wherein the valve is an electrohydraulic pressure relief valve, configured to discharge a fluid in the hydraulic circuit based on a set point pressure.

3. The power management system of claim 2, wherein the controller is configured to regulate the set point pressure associated with the electrohydraulic pressure relief valve in order to control the pressure in the hydraulic circuit.

4. The power management system of claim 3, wherein the controller is further configured to control the set point pressure associated with the electrohydraulic pressure relief valve progressively by incremental pressure values.

5. The power management system of claim 1, wherein the controller is further configured to control the pressure in the hydraulic circuit in the predetermined manner such that a change of the torque load placed on the power generation apparatus lies below a threshold rate.

6. The power management system of claim 1, wherein the hydraulic circuit is associated with a vibratory apparatus of a paving compactor.

7. The power management system of claim 6, wherein the controller is further configured to control the pressure in the hydraulic circuit to a steady state pressure as required by the vibratory apparatus.

8. The power management system of claim 1, wherein the power generation apparatus comprises a prime mover and a power take-off unit configured to be driven by the prime mover, and wherein the power take-off unit is drivably coupled to the pump.

9. The power management system of claim 8, wherein the threshold torque is a design torque limit of the power take-off unit.

10. A machine comprising:
a power generation apparatus;
a pump drivably coupled to the power generation apparatus;
a valve in fluid communication with the pump, wherein the pump and the valve are components of a hydraulic circuit;
an implement driven by a fluid from the hydraulic circuit;
a controller communicably coupled to the valve, wherein the controller is configured to selectively regulate the valve in order to control a pressure in the hydraulic circuit in a predetermined manner such that a torque load placed on the power generation apparatus by the pump lies below a threshold torque.

11. The machine of claim 10, wherein the valve is an electrohydraulic pressure relief valve configured to discharge the fluid in the hydraulic circuit based on a set point pressure.

12. The machine of claim 11, wherein the controller is configured to regulate the set point pressure associated with the electrohydraulic pressure relief valve in order to control the pressure in the hydraulic circuit.

13. The machine of claim 12, wherein the controller is further configured to control the set point pressure associated with the electrohydraulic pressure relief valve progressively by incremental pressure values.

14. The machine of claim 10, wherein the controller is further configured to control the pressure in the hydraulic circuit in the predetermined manner such that a change of the torque load placed on the power generation apparatus lies below a threshold rate.

15. The machine of claim 10, wherein the machine is a paving compactor, and wherein the implement is a vibratory apparatus of the paving compactor, and wherein the controller is further configured to control the pressure in the hydraulic circuit to a steady state pressure as required by the vibratory apparatus.

16. A method of managing power in a power generation apparatus drivably coupled to a pump, the method comprising:
determining a threshold torque associated with the power generation apparatus; and
regulating a valve in fluid communication with the pump in order to control a pressure in a predetermined manner in a hydraulic circuit such that a torque load placed on the power generation apparatus by the pump lies below the threshold torque.

17. The method of claim 16, wherein the valve is an electrohydraulic pressure relief valve configured to discharge a fluid in the hydraulic circuit based on a set point pressure, the method further comprising, regulating the set point pressure associated with the electrohydraulic valve in order to control the pressure in the hydraulic circuit.

18. The method of claim 17 further comprising, increasing the set point pressure associated with the electrohydraulic pressure relief valve progressively by incremental pressure values.

19. The method of claim 16 further comprising, increasing the pressure in the hydraulic circuit in the predetermined manner such that a change of the torque load placed on the power generation apparatus lies below a threshold rate.

20. The method of claim 16, wherein the hydraulic circuit is associated with a vibratory apparatus of a paving compactor, the method further comprising, increasing the pressure in the hydraulic circuit to a steady state pressure as required by the vibratory apparatus.
